(19) United States
(12) Patent Application Publication
(10) Pub. No.: US 2002/0085973 A1
(43) Pub. Date: Jul. 4, 2002

(54) Preparing metal nitride thin film employing amine-adduct single-source precursor

(76) Inventor: Joon Taik Park, Taejon (KR)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/960,611

(22) Filed: Sep. 20, 2001

Related U.S. Application Data
(63) Continuation-in-part of application No. PCT/KR01/00107, filed on Jan. 22, 2001.

(30) Foreign Application Priority Data
Jan. 21, 2000 (KR) 10-2000-0002958

(51) Int. Cl. C01B 21/00; C01F 3/00

(52) U.S. Cl. 423/351; 423/495

(57) ABSTRACT

The present invention relates to a process for preparing metal nitride thin film by chemical deposition employing amine-adduct single-source precursor at low temperatures. In accordance with the present invention, the chemical deposition is performed at low temperatures with a relatively cheap silicon substrate instead of expensive sapphire, which makes possible the economical preparation of the nitride thin film. Furthermore, since the invented process can eliminate the problems confronted in the post electrode deposition caused by insulating substrate, it can be practically applied to the development of new materials and the preparation of multi-layer thin film.

### RELATED APPLICATIONS

This application is a continuation-in-part under 35 U.S.C. §356(c) claiming the benefit of the filing date of PCT Application No. PCT/KR01/00107 designating the United States, filed Jan. 22, 2001 and published in English as WO 01/53565 A1 on Jul. 26, 2001, which claims the benefit of the earlier filing date of Korean Patent Application No. 2000/2958, filed Jan. 21, 2000. The publication No. WO 01/53565 A1 is incorporated herein by reference.

### BACKGROUND OF THE INVENTION

1. Field of the Invention

The present invention relates to a process for preparing metal nitride thin film employing amine-adduct single-source precursor, more specifically to a process for preparing metal nitride thin film by chemical vapor deposition employing amine-adduct single-source precursor at a low temperature.

2. Description of the Related Art

Semiconductors made of XIII group metal nitride compounds are optical elements, made of the mixed crystals from gallium nitride (GaN), aluminum nitride (AlN), and indium nitride (InN), with the application range from the blue range to ultraviolet light. These semiconductors are applied to natural color display equipments, equipments for ultraviolet emission and reception, and the wide band gap for short wavelength laser equipments (from 1.9 to 6.3 eV, from 650 to 200 nm).

For the preparation of the nitride semiconductor thin film has been mainly used chemical vapor deposition (CVD) method employing dual-source precursors due to the facility of thin film growth and fine structure control, and the possibility of mass production. This method, however, is reported to have several problems for the preparation of nitride thin films of good quality: First, trimethylmetal and ammonia are used for the chemical deposition of a thin film, and the temperature of the substrate should be higher than 900□ due to the high thermal stability of ammonia. This high temperature leads to the low content of nitrogen, which results in the high concentration of n-type carrier. Therefore, p-type semiconductor devices are difficult to be prepared by this process (see: S. Stride and H. Morkd, J. Vac. Sci. Technol., 10:1237, 1992).

Besides, when grown to the multi-player thin film, thermally unstable films cannot be deposited on the same substrate because the interlayer diffusion occurs more actively at high temperature; second, it is difficult to achieve quantitative chemical composition of thin film because more than two precursors with different vapor pressures are used; third, trimetylmetal and ammonia used as the thin film precursors are difficult to deal with due to the high reactivity and toxicity, and the quality of the thin film decreases during the prolonged research by the vapor pressure decrease and the precursor decomposition.

To overcome these problems, it has been actively studied recently to use organometallic compounds that include quantitative amount of metal and nitrogen as single-source precursors. Single-source precursors are advantageous in many aspects. First, the facile formation of the thin film with exact composition is possible because the molecules of the single-source precursors contain fixed quantity of chemical elements needed for the preparation of the thin film. Second, chemical bonds among the thin film elements already exist so that the surface diffusion and the activation energy for the bond formation among the elements on the surface of the substrate are not much required. Third, single-source precursors have very low reactivity and toxicity, and easy to deal with and to purify by recrystallization or sublimation. Besides, the deposition temperature of the thin film is relatively low to make it possible to use thermally unstable materials as substrates and to prevent interlayer diffusion. As examples, a single-source precursor [(Me₂N)(N₃)Ga(μ-NMe₂)]₂ has been used to prepare a gallium nitride thin film at 580° C. (see: D. A. Neumayer et al., J. Am. Chem. Soc., 117:5893, 1995) and another single-source precursor [(N₃)₂Ga(CH₂CH₂CH₂Nme₂)] has been reported to be used for the preparation of a gallium nitride thin film at 750° C. (see: R. A. Fischer et al., J. Cryst. Growth, 170:139, 1997).

However, even though the thin films described above are prepared at lower temperature than used in the past, the interlayer diffusion and the quality decrease due to the vapor pressure decrease and the precursor decomposition are still to be solved. Besides, the unit cost of production is high because sapphire is used as the substrate for the thin film deposition. Therefore, there are strong reasons for developing a economical process for the preparation of the thin film at lower temperature to overcome the interlayer diffusion and the quality decrease of the thin film.

### SUMMARY OF THE INVENTION

The present inventors made an effort to develop the economical process for the preparation of the thin film at lower temperature to overcome the interlayer diffusion and the quality decrease of the thin film, and discovered that metal nitride thin films can be prepared by the deposition of XIII group metal nitride compounds including gallium nitride onto silicon substrate using amine-adduct precursors R₂(N₃)M:D.

An aspect of the present invention provides a chemical compound satisfying the following formula:

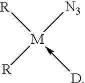

In the formula, D represents a ligand configured to block dimerization or polymerization; M represents a metal; R represents hydrogen, halogen or an alkyl substituent; and R's can be either same or different. D is selected from the group consisting of NH₃, NH₂R and NH₂NR₂. M is selected from the group consisting of aluminum, gallium and indium. The alkyl substituent of R is selected from the group consisting of methyl, ethyl, n-propyl, i-propyl, and t-butyl. The halogen substituent of R is chlorine or bromine.

Another aspect of the present invention provides a method of making the chemical compound. The method comprises providing a compound having the formula of [R₂M(-μ-NH₂)]₃; and reacting the compound with a azide.

A further aspect of the present invention provides a method of producing a metal nitride thin film. The method provides providing a substrate having a surface in a chamber; heating the substrate to a temperature sufficient to decompose the chemical compound; and vaporizing the chemical compound within the chamber so as for the compound to contact the surface of the substrate and form a metal nitride thin film in the course of decomposition thereof. The substrate is heated to a temperature from about 300° C. to about 500° C.; preferably from about 350° C. to about 450° C., more preferably, about 350° C. to about 400° C. When vaporizing the compound, the chamber is kept under vacuum. The pressure within the chamber is less than 1.0×10⁻⁶ torr. The vaporization comprises heating the chemical compound. The heating of the chemical compound is up to a temperature from about 70° C. to about 200° C. Preferably, the temperature of heating is from about 80° C. to about 150° C., more preferably, from about 90° C. to about 120° C. The substrate is made of silicon, sapphire or SiC. The method further comprising forming a buffer layer over the metal nitride thin film. The buffer layer comprises GaN or AlN. The metal nitride thin film comprises GaN, AlN, InN, AlGaN, AlInN or a mixture thereof.

### DETAILED DESCRIPTION OF THE PREFERRED EMBODIMENT

The crystal structure of a multi-player thin film is generally known to depend on the substrate used and the orientation. To obtain hexahedral gallium nitride thin films was usually used sapphire as the substrate, especially with the c-faced crystal structure. It is because that sapphire is stable to high temperature, has a hexagonal symmetry, and easy pre-treatment is possible. However, when the semiconductor material, silicon is used as the substrate, the post electrode formation process is facilitated, the change of the substrate is possible, and the separation of the final elements is facilitated compared to insulating sapphire.

One aspect of the present invention provides a chemical compound for use in metal nitride thin film deposition. The chemical formula of the compound is as follows:

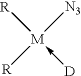

Wherein,

D represents NH₃, NH₂R, or NH₂NR₂;

M represents Ai, Ga, or In; and

R represents H, Me, Et, n-Pr, i-Pr, t-Bu, Cl, or Br.

The chemical compound is designed so as to provide an exact stoichiometric composition of the metal nitride to be deposited on a substrate in a chemical vapor deposition process. Further the chemical compound is designed to improve or at least maintain the evaporability required in the chemical vapor deposition process. This is done by the ligand D, which blocks automatic polymerization or dimerization of the remainder of the composition, which might otherwise occur.

The process for the preparation of metal nitride thin films using the chemical compound, which is also referred to as amine-adduct single-source precursors includes a step to vaporize the amine-adduct single-source precursor (I) by placing it onto the substrate and then heating at 350 to 400° C. under the pressure of 0.5×10⁻⁷ to 1.5×10⁻⁷ Torr; a step for the formation of the buffer layer by controlling the vapor pressure of the precursor from 1.0×10⁻⁶ to 3.0×10⁻⁶ Torr followed by the chemical deposition for 1.5 to 2.0 hours; and a step for the preparation of the metal nitride thin film by the chemical deposition of the buffer layer for 12 to 24 hours under the pressure of 1.0×10⁻⁶ to 3.0×10⁻⁶ Torr.

The process for the preparation of metal nitride thin films using the chemical deposition at low temperature of the present invention is further illustrated in detail by the following steps.

Step 1: Vaporization of the single-source precursor

The amine-adduct single-source precursor (I) is placed onto the substrate and then heated at 350 to 400° C. under the pressure of 0.5×10⁻⁷ to 1.5×10⁻⁷ Torr to vaporize the single-source precursor: At this time, silicon, sapphire, and SiC can be used for the substrate, and silicon is preferred. The temperature of the substrate can be measured using an optical thermometer or be calculated from the amount of current using the correction diagram of the correlation between temperature and current passing though the silicon substrate.

Step 2: Formation of the buffer layer

The buffer layer is obtained by controlling the vapor pressure of the precursor from 1.0×10⁻⁶ to 3.0×10⁻⁶ Torr followed by the chemical deposition for 1.5 to 2.0 hours: The buffer layer obtained is not limited to special types, and it can include GaN or AlN depending on the amine-adduct single-source precursor.

Step 3: Preparation of the metal nitride thin film

The metal nitride thin film is prepared by the chemical deposition of the buffer layer for 12 to 24 hours under the pressure of 1.0×10⁻⁶ to 3.0×10⁻⁶ Torr: The thin film, in this case, is preferred to contain a mixture of AlN, GaN, InN, AlGaN, GaInN, AlInN, or AlGaInN. The equipment used for the chemical deposition of the metal nitride is not limited to special types, however, the high vacuum (10⁻⁷ Torr) chemical deposition equipment with an oil diffusion pump and liquid nitrogen traps is preferred. The high vacuum equipment uses a flange made of stainless steal pipe, and it is in the shape of a jointed cold wall using the copper gasket. It is also equipped with high vacuum valves to control the vacuum of the sample tube and the vapor pressure of the precursor.

The present invention is further illustrated by the following examples, which should not be taken to limit the scope of the invention.

### EXAMPLE 1

Preparation of Et₂(N₃)Ga:NH₃

0.88 g [Et₂Ga(-μ-NH₂)]₃ was dissolved in Et₂O, and 0.26 g azidic acid was added dropwise at 60° C. with stirring. The reaction temperature was raised to room temperature and then the reaction solution was stirred for 2 hours. After the completion of the reaction, the solvent was removed under vacuum to give 0.91 g of colorless liquid. The liquid was purified by distillation to yield Et₂(N₃)Ga:NH₃ with the melting point of −10° C.

¹H NMR (CDCl₃, 20° C.) δ0.56 (q, Ga—CH₂CH₃), 1.12 (t, Ga—CH₂CH₃), 3.05 (s, N—H); ¹³C NMR (CDCl₃, 20° C.) δ2.80 (Ga—CH₂CH₃), 9.24 (Ga—CH₂CH₃); MS (70 eV) m/z 140 (M+-[Et+NH₃]; IR (N₃) 2073, 2254 cm⁻⁷.

### Example 2

Preparation of the metal nitride thin film using Et₂(N₃)Ga:NH₃ (I)

0.1 g Et₂(N₃)Ga:NH₃ was placed in the container, and the total pressure was adjusted to 3.0×10⁻⁵ Torr by controlling the valve of the vapor pressure of Et₂(N₃)Ga:NH₃ while silicon (111) wafer was heated at 350° C. under the initial pressure of 1.0×10⁻⁷ Torr, and then chemical deposition was performed for 1.5 hour. The deposited metal gallium nitride thin film was blue-colored and 0.15 μm thick, which was confirmed by the picture of SEM scattered sections. The X-ray diffraction analysis showed the formation of a multi-crystalline GaN buffer layer. The pressure on the buffer layer was increased to 6.0×10⁻⁶ Torr followed by chemical deposition for 12 hours to yield a black gallium nitride thin film. The SEM photograph of fractured sections revealed that the film had a thickness of 2 μm, and the deposition rate was 0.15 μm/hr. Rutherford backscattering spectrometry (RBS) analysis showed that the thin film was consist of 1:1 mole ratio of gallium and nitrogen. A gallium nitride peak was observed at 34.5° when X-ray diffraction analysis of the thin film was performed with changing 2θ from 20° to 80°. Pole figure analysis also confirmed that the thin film has grown to the hexahedral structure. The formation of the multi-crystalline buffer layer was confirmed by analyzing the TEM image, and electron diffraction analysis confirmed that the formation of gallium nitride grown as multi-layer in the shape of column on the buffer layer.

### Example 3

Preparation of Metal Nitride Thin Film Employing Et₂(N₃)Ga:NH₃ (II)

The metal nitride thin film was prepared by the same method used in example 2 except silicon wafer was heated at 400° C. As the result, a black gallium nitride was prepared with the thickness of 2.2 μm and the film formation rate of 0.16 μm/hr, which was measured by the picture of SEM scattered sections. The other characteristics of the deposited thin film were identical to the thin film prepared in example 2.

As clearly described and demonstrated as above, the present invention provides the process for the preparation of metal nitride thin films by the chemical deposition at low temperature employing amine-adduct single-source precursors. In accordance with the present invention, the chemical deposition is performed at low temperature with a cheap semiconductor, silicon as a substrate instead of expensive sapphire, which makes it possible the economical preparation of the nitride thin film. Furthermore, since the invented process can eliminate the problems confronted in the post electrode preparation process caused by insulating substrate, it can be practically applied to the development of new materials and the preparation of multi-layer thin film.

Although the preferred embodiments of present invention have been disclosed for illustrative purpose, those who are skilled in the art will appreciate that various modifications, additions, and substitutions are possible, without departing from the spirit and scope of the invention as disclosed in the accompanying claims.

What is claimed is:

1. A chemical compound satisfying the following formula: 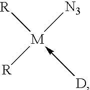
wherein
D represents a ligand configured to block dimerization or polymerization;
wherein M represents a metal;
wherein R represents hydrogen, halogen or an alkyl substituent; and
wherein the R's can be either the same or different.

2. The chemical compound of claim 1, wherein D is selected from the group consisting of NH₃, NH₂R and NH₂NR₂.

3. The chemical compound of claim 1, wherein M is selected from the group consisting of aluminum, gallium and indium.

4. The chemical compound of claim 1, wherein the alkyl substituent of R is selected from the group consisting of methyl, ethyl, n-propyl, i-propyl, and t-butyl.

5. The chemical compound of claim 1, wherein the halogen substituent of R is chlorine or bromine.

6. A method of making the chemical compound of claim 1, comprising
providing a compound having the formula of [R₂M(-μ-NH₂)]₃; and
reacting the compound with a azide.

7. A method of producing a metal nitride thin film, comprising:
providing a substrate having a surface in a chamber;
heating the substrate to a temperature sufficient to decompose the chemical compound of claim 1; and
vaporizing the chemical compound within the chamber so that the compound contacts the surface of the substrate and forms a metal nitride thin film in the course of decomposition thereof.

8. The method of claim 7, wherein the substrate is heated to a temperature from about 300° C. to about 500° C.

9. The method of claim 7, wherein the substrate is heated to a temperature from about 350° C. to about 450° C.

10. The method of claim 7, wherein the substrate is heated to a temperature from about 350° C. to about 400° C.

11. The method of claim 7, wherein when vaporizing the compound, the chamber is kept under vacuum.

12. The method of claim 7, wherein when vaporizing the compound, the pressure within the chamber is less than 1.0×10⁻⁶ torr.

13. The method of claim 7, wherein the vaporization comprises heating the chemical compound.

14. The method of claim 7, wherein the vaporization comprises heating the chemical compound at a temperature from about 70° C. to about 200° C.

15. The method of claim 7, wherein the vaporization comprises heating the chemical compound at a temperature from about 80° C. to about 150° C.

16. The method of claim 7, wherein the vaporization comprises heating the chemical compound at a temperature from about 90° C. to about 120° C.

17. The method of claim 7, wherein the substrate is made of silicon, sapphire or SiC.

18. The method of claim 7, further comprising forming a buffer layer over the metal nitride thin film.

19. The method of claim 18, wherein the buffer layer comprises GaN or AlN.

20. The method of claim 7, wherein the metal nitride thin film comprises GaN, AlN, InN, AlGaN, AlInN or a mixture thereof.
